(19) United States
(12) Patent Application Publication
(10) Pub. No.: US 2017/0329770 A1
(43) Pub. Date: Nov. 16, 2017

(54) SYSTEM AND METHOD FOR FACILITATING DATA MIGRATION

(71) Applicant: QUADROtech Solutions AG, Zug (CH)

(72) Inventors: Peter Kozak, Zug (CH); Wayne Humphrey, Zug (CH); Mike Weaver, Enfield, CT (US); Tony Redmond, Dublin (IE)

(21) Appl. No.: 15/592,052

(22) Filed: May 10, 2017

Related U.S. Application Data
(60) Provisional application No. 62/334,112, filed on May 10, 2016.

(51) Int. Cl. G06F 17/30

(52) U.S. Cl. CPC G06F 17/303; G06F 17/30294; G06F 17/30569

(57) ABSTRACT

Disclosed is a computer implemented method of facilitating data migration. The computer implemented method includes receiving, using a processor, at least one data characteristic associated with a source data, wherein the source data is stored in a source repository. Further, the computer implemented method includes receiving, using the processor, at least one repository characteristic associated with at least one target repository. Further, the computer implemented method includes analyzing, using the processor, the at least one data characteristic and the at least one repository characteristic. Yet further, the computer implemented method includes determining, using the processor, at least one target repository based on the analyzing. Moreover, the computer implemented method includes migrating, using the processor, the source data to the at least one target repository.

### FIELD OF THE INVENTION

The present disclosure generally relates to data migration. More specifically, the present disclosure relates to a system and method for migrating application data from legacy systems to target systems.

### BACKGROUND OF THE INVENTION

Email systems such as Microsoft Exchange Server store many different types of data records that are useful in communications and conducting business. Some of these record types are held in repositories that have been obsoleted by recent developments in more modern implementations of email servers, such as the cloud-based Exchange Online server running inside Office 365. Public Folders are a good example of an obsolete repository. First introduced in 1996, public folders store different types of items such as email messages, calendar appointments, and contact records. Those who wish to move to a cloud-based system such as Exchange Online are limited in their ability to use the data held in repositories such as Public Folders because they are not easily transferrable to more modern implementations, such as Office 365 Groups without further analysis. Consequently, businesses lose value from the data they already hold and are unable to take advantage of more modern functionality that is available to them.

Therefore, various migration software systems are available currently. However, each of these migration software systems suffers from known problems when it comes to dynamic data transformation and migration to different target systems based on specific characteristics of the source data. For example, some migration systems have the ability to transform data from a source to a target data format, but (1) the transformation process is hardcoded between predefined systems therefore static and not dynamic; (2) the migration process is not dynamic enough to allow the splitting of the source content to different targets based on the different security boundaries within a container that holds records. (For instance, a Public Folder Subtree); and (3) there are no additional checks implemented to decide based on characteristics/properties of the data where to migrate the data to.

Therefore, there is a need for an improved system and method that can analyze the content held in an obsolete data repository and make a suggestion or decision as to which of the available modern repositories it is most advantageous to move the data into. More specifically, it would be advantageous to have a system and method for assessing many different characteristics of the data while comparing these characteristics to those of the available target systems in order to decide which target system to select for which data and how to transform it. Furthermore, items might be considered on an individual basis or on a group basis, as in the case of a folder holding multiple individual items, each of which might be of a different type.

### SUMMARY

Disclosed is a computer implemented method of facilitating data migration. The computer implemented method includes receiving, using a processor, at least one data characteristic associated with a source data, wherein the source data is stored in a source repository. Further, the computer implemented method includes receiving, using the processor, at least one repository characteristic associated with at least one target repository. Further, the computer implemented method includes analyzing, using the processor, the at least one data characteristic and the at least one repository characteristic. Yet further, the computer implemented method includes determining, using the processor, at least one target repository based on the analyzing. Moreover, the computer implemented method includes migrating, using the processor, the source data to the at least one target repository.

Further, a system for facilitating data migration is disclosed. The system includes a processor configured to receive at least one data characteristic associated with a source data, wherein the source data is stored in a source repository. Further, the processor is configured to receive at least one repository characteristic associated with at least one target repository. Yet further, the processor is configured to analyze the at least one data characteristic and the at least one repository characteristic. Moreover, the processor is configured to determine at least one target repository based on the analyzing and migrate the source data to the at least one target repository.

The present disclosure provides an automated process for analyzing data held in legacy systems which takes the characteristics or properties of the data/records into consideration to determine the most suitable modern target system. The properties and characteristics include, but are not limited to, size, age, content type, date last accessed, and ownership. For instance, an object that has not been accessed in seven years can be considered obsolete data and might therefore be recommended for deletion. By comparison, a public folder that is accessed by multiple users on a sustained basis for the last three months might better be moved to a more modern collaboration mechanism, such as an Office 365 Group.

The process is not limited to public folders. It is envisaged that the same approach can be used to analyze, assess, and process data drawn from other IT systems. For example, files stored in a document management system or a shared file server could be assessed to determine whether they should be moved to a platform such as SharePoint Online or to OneDrive for Business. Another example might be in the case where a company wishes to move data from an archiving system such as Veritas Enterprise Vault. In this case, the archived items can be analyzed and a decision made as to what data needs to be moved forward and what is now obsolete and no longer required for retention purposes. In all cases, the same methodology applies: examine the source data, compare it to a set of criteria, and make a decision or suggestion as to the optimal target platform.

The next phase of the process is to invoke suitable migration tools to perform the actual movement of data as determined by the recommendation. The migration tools can be provided as integrated functionality or through separate and standalone tools that are capable of understanding and executing directives provided through the analysis. Finally, a validation phase is performed to ensure that the old data has been moved successfully to the correct target repositories and that the moved data is intact, functional, and secure in its new location.

The disclosed computer implemented method (software) is unique when compared with other known solutions in that it provides an automated and dynamic way to find the most advantageous modern target system for legacy data by analyzing the data held in an obsolete data repository. The software assesses many different characteristics of the data and compares these characteristics to those of the available target systems in order to decide which target system to select for which data. Items might be considered on an individual basis or on a group basis, as in the case of a folder holding multiple individual items, each of which might be of a different type. Furthermore, as the software is aware of the available features and target formats on the modern system, it suggests the best transformation methodology between data formats to keep the characteristics of the data in the modern system.

The disclosed is unique in that the overall architecture and methodology of the system is different from other known systems. More specifically, the disclosed system is unique due to the presence of: (1) the ability to determine the properties, features and characteristics of the target system; (2) the ability to deeply analyze the characteristics of the source data in the legacy system taking different unrelated properties into consideration. Furthermore, the process associated with the aforementioned invention is likewise unique and different from known processes and solutions: (1) it provides direct comparison between characteristics of the source and target systems involved; (2) it suggests the most suitable target based on execution of different checks on different data properties and data characteristics in the source system; (3) it is dynamic and is able to split the data based on its characteristics to different suitable target systems. Among other things, it is an object of the present invention to provide a reliable process that does not suffer from any of the problems or deficiencies associated with prior solutions.

Data systems contain a significant amount of valuable data that might remain in place for long periods of time. As time goes by, new systems and methods of processing are created that may be better repositories for this data. As older systems are replaced, the data needs to be preserved and migrated to one of many modern systems. These modern systems have unique features and functionality that might differ from the previous data system. The present invention consists of a computerized process that assesses existing data and decides on which modern system is best suited as a transfer target and how the data should be transformed. To make an optimum determination of the target system, multiple properties of the data are considered and measured through an advanced process of analysis. The determination arrived at is the system best suited to host the data in such a way that its functionality and usefulness are retained. The method is well suited to transfer large quantities of data from old to new systems in a short period of time.

### BRIEF DESCRIPTION OF THE DRAWINGS

FIG. 1 illustrates a block diagram of a system for facilitating data migration, according to some embodiments.

FIG. 2 is a flowchart of a computer implemented method of facilitating data migration according to some embodiments.

FIG. 3 illustrates a system for facilitating data migration between a source system and a target system, in accordance with some embodiments.

FIG. 4 illustrates a flowchart of a method that may be executed by an analysis engine of the system of FIG. 3.

FIG. 5 illustrates a flowchart of a method of the initialization phase of the analysis engine of the system of FIG. 3.

FIG. 6 describes a schema created by a repository engine and consumed by the analysis engine of the system of FIG. 3.

FIG. 7 describes a rule for analysis by the analysis engine of the system of FIG. 3.

FIG. 8 illustrates a method showing how the results of the checks are stored in a check-table by the analysis engine of the system of FIG. 3.

FIG. 9 illustrates a method shows how a single check is performed by the analysis engine of the system of FIG. 3.

FIG. 10 illustrates a method of concluding the analyzes and suggest target process performed by the analysis engine of the system of FIG. 3.

### DETAILED DESCRIPTION OF THE INVENTION

All descriptions are for the purpose of showing selected versions of the present invention and are not intended to limit the scope of the present invention.

Non-limiting and non-exhaustive embodiments of the present invention are described with reference to the preceding figures, wherein like reference numerals refer to like parts throughout the various views unless otherwise precisely specified.

In the description herein, general details of the present invention are provided in flow diagrams to provide a general understanding of the programming methods that will assist in an understanding of embodiments of the present invention. One skilled in the relevant art of programming will recognize, however, that the present invention can be practiced without one or more specific details, or in other programming methods. Referenced throughout this specification to “one embodiment” or “an embodiment” means that a particular feature, structure or characteristic described in connection with the embodiment is included in at least one embodiment of the present invention. Thus, the appearance of the phrases “in one embodiment” or “in an embodiment” in places throughout this specification are not necessarily all referring to the same embodiment. Furthermore, the particular features, structures, or characteristics may be combined in any suitable manner in one or more embodiments.

The present disclosure provides a system and method of advanced data analysis for determining the most suitable target system for data stored on one or more legacy systems.

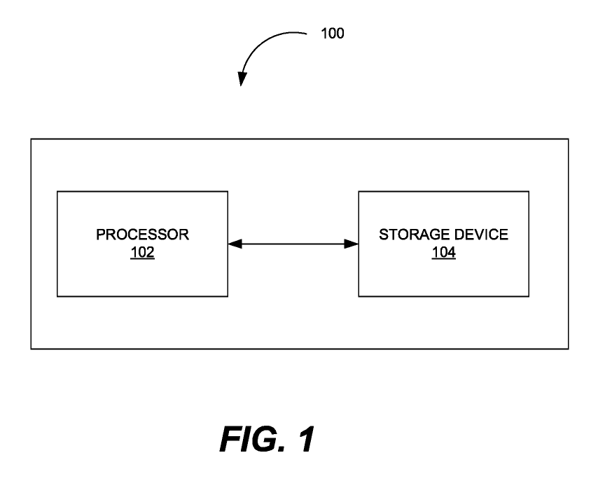

FIG. 1 illustrates a block diagram of a system 100 for facilitating data migration according to some embodiments. The system 100 may include a processor 102 and a storage device 104, wherein the processor 102 is communicatively coupled to the storage device 104. The storage device 104 may be configured to store computer instructions, which may be executed by the processor 102.

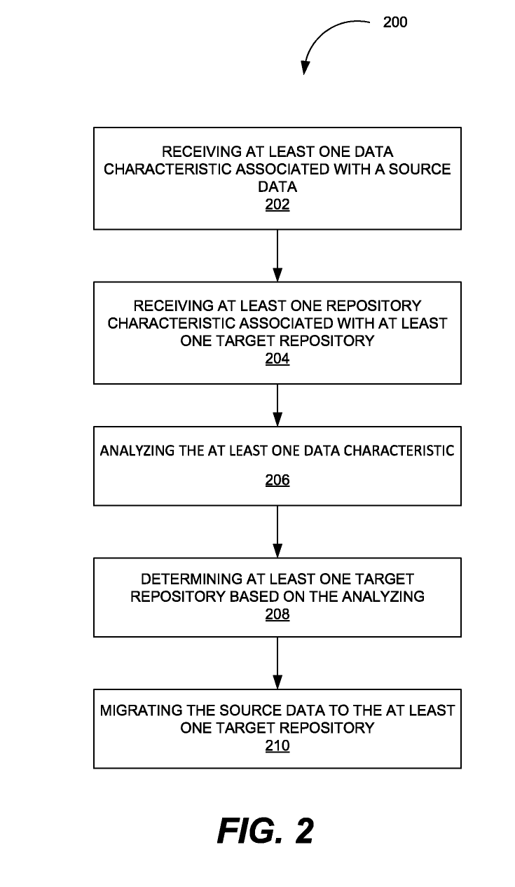

FIG. 2 is a flowchart of a computer implemented method 200 of facilitating data migration according to some embodiments. At 202, the method 200 may include receiving, using the processor 102, one or more data characteristics associated with a source data, wherein the source data is stored in a source repository. The method 200 may also include analyzing, using the processor 102, one or both of the source data and a metadata associated with the source data to determine the one or more data characteristics. The one or more data characteristics may include one or more of a size, an age, a content type and an ownership. The source data may include a public folder. At 204, the method 200 includes receiving, using the processor 102, one or more repository characteristics associated with one or more target repositories.

At 206, the method 200 includes analyzing, using the processor 102, the one or more data characteristics and one or more repository characteristics. Further, the analyzing may include comparing the one or more data characteristics with multiple data characteristics associated with multiple repository characteristics. The storage device 104 may be configured to store an association between the multiple data characteristics and the multiple repository characteristics.

The method 200 may further include assigning, using the processor 102, one or more weights to the one or more data characteristics, wherein the analyzing is performed based on the one or more weights.

At 208, the method 200 includes determining, using the processor 102, one or more target repositories based on the analyzing at 206. The one or more target repositories are characterized by at least one hardware characteristic and at least one software characteristic. Further, the one or more data characteristics may include one or more of a mode of access, a security level and a throughput, wherein the one or more target repositories may be compatible with respectively one or more of the mode of access, the security level and the throughput.

Further, the analyzing (at 206) may also include executing one or more rules against the one or more data characteristics. Accordingly, the determining (at 208) the one or more target repositories may be based on a result of executing the one or more rules. The one or more rules may include multiple rules, wherein the analyzing (at 206) may further include determining a weighted combination of results of executing the multiple rules, wherein the determining (at 208) the one or more target repositories are based on the weighted combination.

Yet further, the method 200 may include determining, using the processor 102, one or more repository characteristics associated with the one or more target repositories, wherein analyzing the one or more data characteristics may be based on the one or more repository characteristics.

Moreover, the method 200 may include determining, using the processor 102, at least one confidence value associated with the one or more target repositories, wherein a confidence value associated with a target repository is indicative of an extent of suitability of the target repository for storing the source data.

Further, the method 200 may include presenting, using a presentation device, indication of the one or more target repositories to a user. In response, receiving, using an input device, a selection of a target repository of the at least one target repository.

At 210, the method 200 includes migrating, using the processor 102, the source data to the one or more target repositories.

Further, the method 200 may include transforming, using the processor 102, the source data into a target data based on at least one target schema associated with the one or more target repositories.

Moreover, the method 200 may include comprising splitting, using the processor 102, the source data into multiple source data, wherein the one or more data characteristics may include multiple data characteristics. The one or more target repositories may include multiple target repositories associated with the multiple data characteristics.

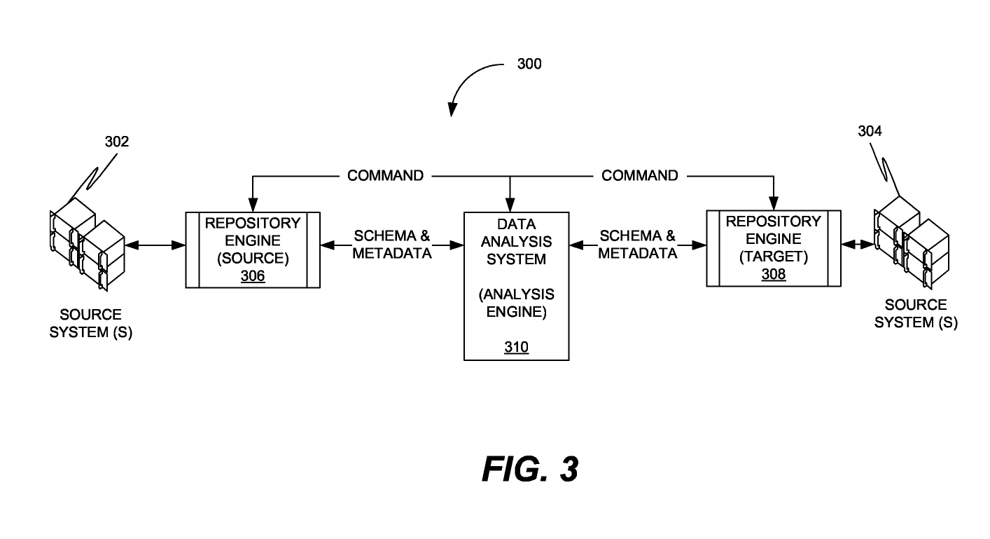

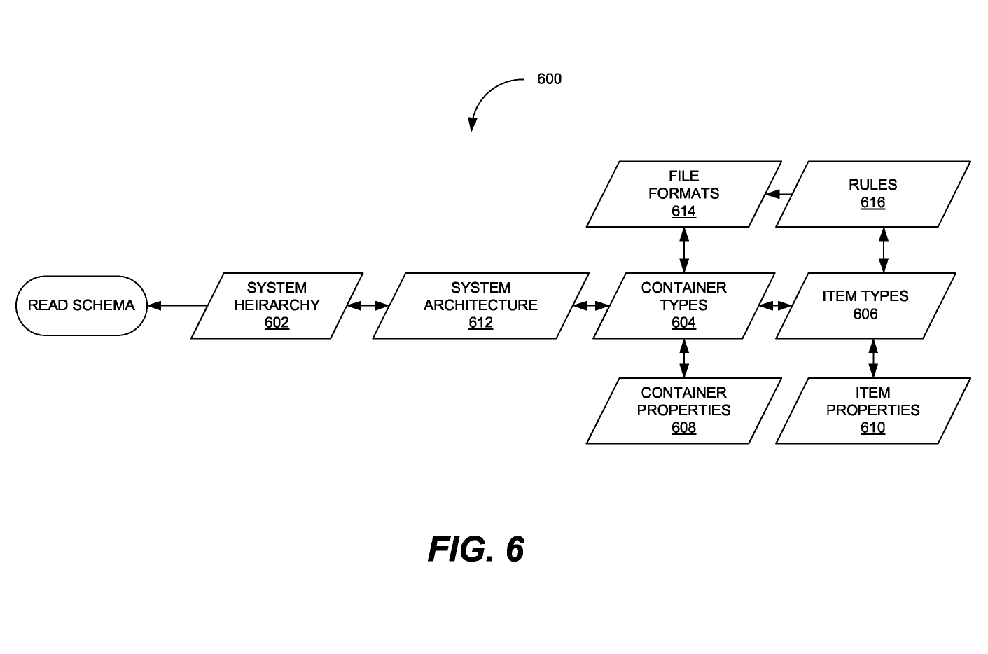

FIG. 3 illustrates a system 300 for facilitating data migration between a source system 302 and a target system 304, in accordance with some embodiments. The system 300 may include repository engines 306-308. The repository engine 306 has the ability to create a schema for the source system 302. The repository engine 308 has the ability to create a schema for the target system 304. Further, the repository engines 306-308 may be configured to publish data about “Systems Architecture” and “System hierarchy”, as described in further detail in conjunction with FIG. 6 below. Further, the repository engines 306-308 may be configured to gather the properties required to perform analysis by the analysis engine 310. It furthermore describes the possible input and output formats to the system 300. The analysis engine 310 analyzes the source characteristics and assigns weights to the different data properties taking the available features of the target system 304 into consideration.

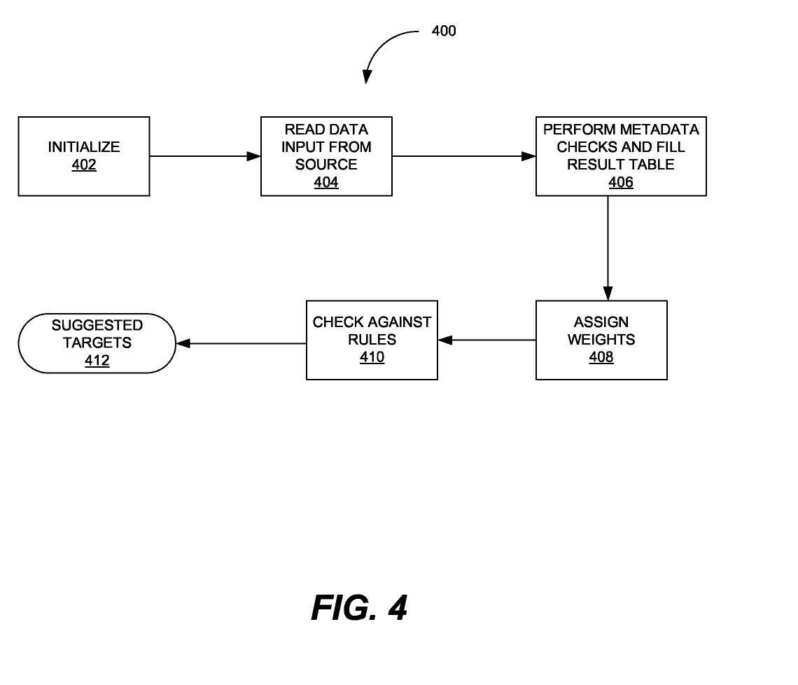

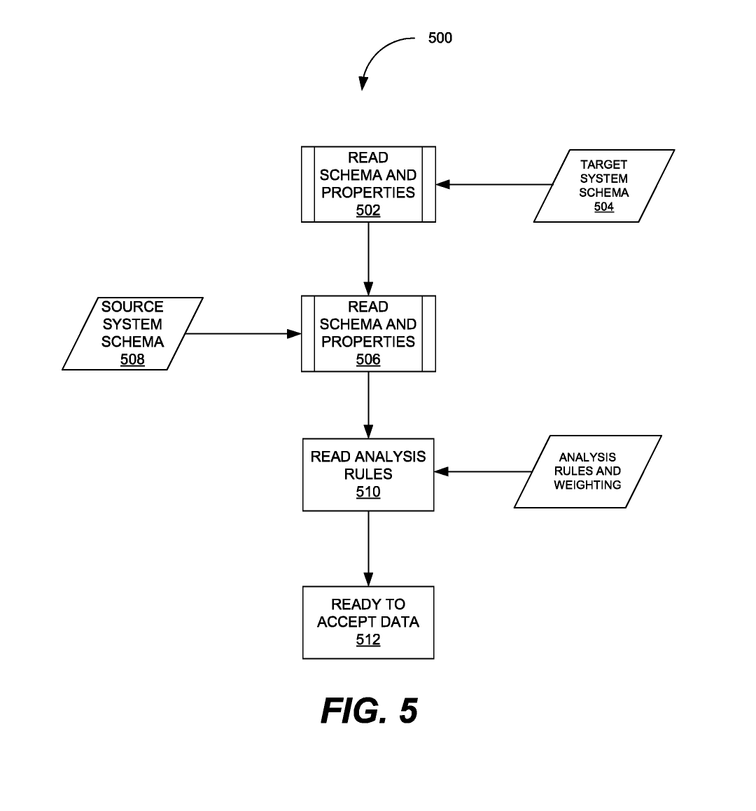

FIG. 4 illustrates a flowchart of a method 400 that may be executed by the analysis engine 310. At 402, the method 400 includes an initializing phase that ensures that the analysis engine 310 is aware of all systems involved in the analysis (such as, the source and target schemas). Further, the required rules for the analysis are loaded. The initializing phase is described in further detail in conjunction with FIG. 5 below.

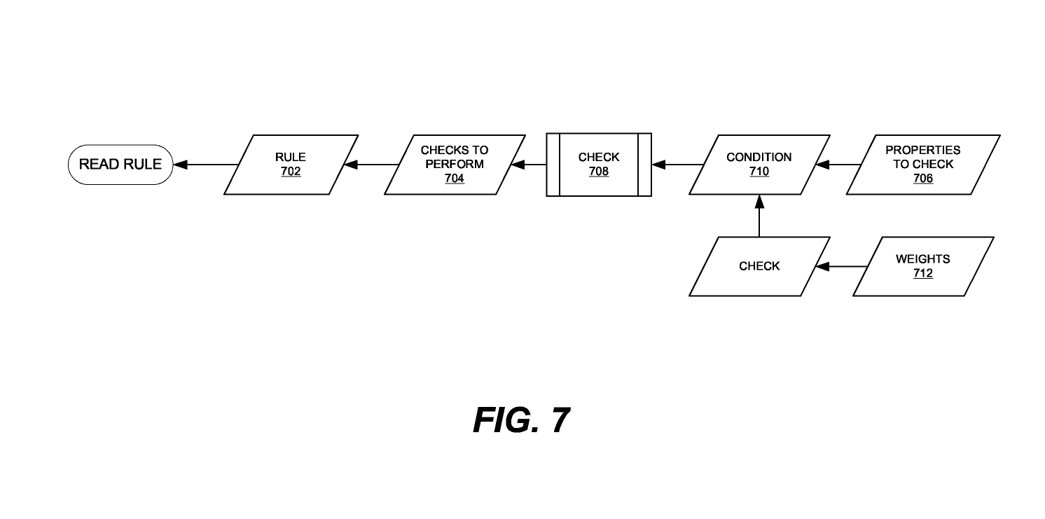

Then at 404, collected meta data is read and then the necessary checks are performed at 406. The results of the checks are preserved (such as in a results table). Then, at 408, weights are assigned to the results, based on rule definitions, described in further detail in conjunction with FIG. 7 below. Next, at 410, the assigned weights are checked against conditions of the rule. Finally, the method 400 provides an output consisting of suggested targets at 412. For example, the output may include top three suiting targets represented by a percentage value.

FIG. 5 illustrates a flowchart of a method 500 of the initialization phase of the analysis engine 310. At 502, the analysis engine 310 reads target schema 504. At 506, the analysis engine 310 reads source schema 508. The source schema 508 and the target schema 504 may be created by the repository engines 306-308. Next, at 510, the analysis engine 310 reads rules with the necessary checks to perform. Thereafter, the system 300 is ready to accept data for analysis and target suggestion at 512.

FIG. 6 describes a schema 600 created by one of the repository engines 306-308 and consumed by the analysis engine 310. A System Hierarchy part 602 of the schema describes the different hierarchy levels within a system for containers that can hold other containers (container types 604) or items (item types 606). The container types 604 and the item types 606 are described in separate subsets of the schema. Further, container properties 608 and item properties 610 may be described. For example, for Microsoft Exchange, the hierarchy would be described in Container types of Exchange Organization, Database Availability Group, Mailbox Database, Mailbox and a Folder. The different types of items that may be stored in the Folder are defined in the Item Types section of the schema. Both Containers and Items contain for every declared entry the Property Names and Types that should be accessed by the analysis. To follow up on the Microsoft Exchange example above, Folder (Container) Properties could contain but are not limited to Default Message Class, the Access Control List, different MAPI properties like “is Mail Enabled” or “has Custom Forms” and the declaration of statistics calculated based on the content of a folder like Youngest, Median and Oldest Item, or Message Class Statistics per time period. In addition to the system hierarchy 602, a system architecture 612, the container types 604, and the item types 606, the schema also contains the available file formats 614 for input and output. The target schema also contains a ruleset 616 for the analysis as described in further detail in conjunction with FIG. 7 below.

FIG. 7 describes a rule 702 for analysis. The rule 702 may be consumed by the analysis engine 310 and may be defined as part of the schema transmitted from the target system. A rule set contains different rules that are validated by the analysis engine 310 against the input data to determine the likelihood of a matching repository in a specific target. The rule set may be evolved at each customer and be shared across customers. The rule 702 contains one or more checks 704 that may be performed on defined properties 706. The results of those checks 708 may be compared with one or more conditions 710 specified by the rule 702. All checks 704 may contain a weighting value 712 and are combinable with logical functions including and, or, nor. Further, human intervention may be required for reviewing the rules, resolving conflicts

To follow up on the Microsoft Exchange example above, a part of an Exchange Public Folder Analysis, could be for example a rule “is Folder Active” that checks the “Youngest Item Date” Property, the “Median Item Date” Property and the “Oldest Item Date” Property of a mailbox folder. Those properties could be compared in checks against different conditions like “Youngest Item Date is younger than 4 Weeks AND Median Item Date is younger than 12 Months”. Each check contains a weighting factor to allow adjustment of priorities within a check. For example, “Youngest Item Date” can be rated with a higher weight than “Median Item Date”.

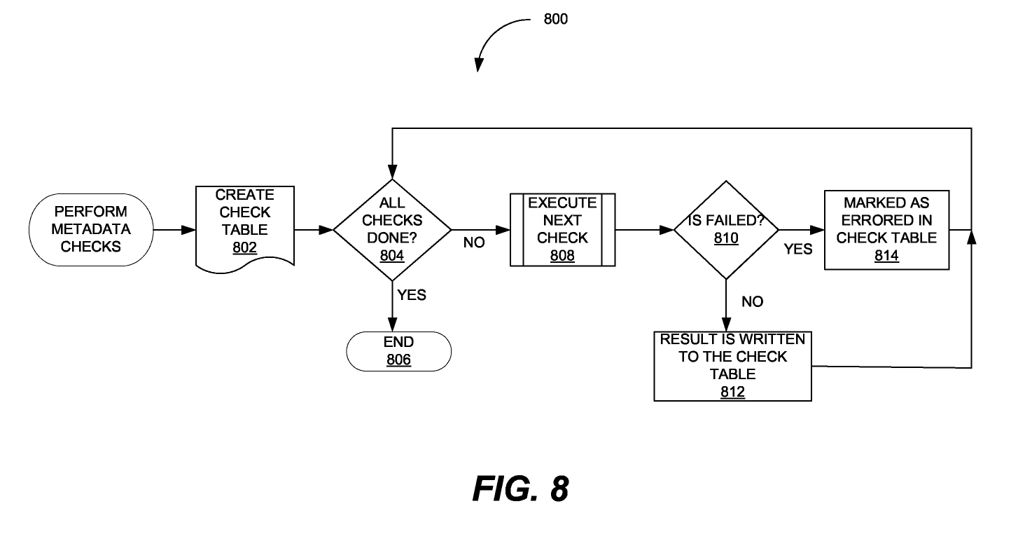

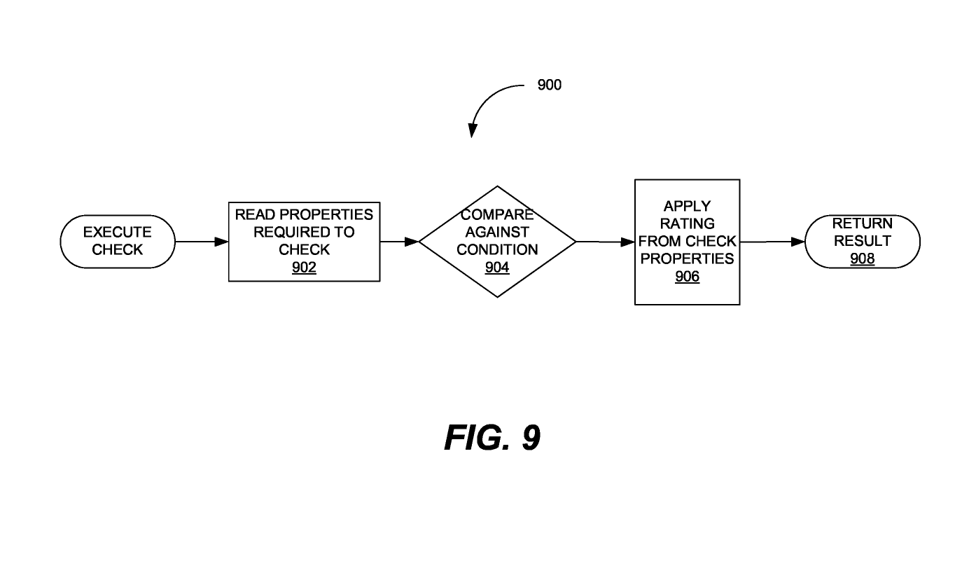

FIG. 8 illustrates a method 800 showing how the results of the checks are stored in a check-table in Memory, Database or File. At 802, the check table is created. At 804, it is checked if all checks have been performed. If it is determined that all checks have been performed, then the method 800 ends at 806. However, at 804, if it is determined that all checks have not been performed, then the method 800 goes to step 808, where the next check is executed. This is explained in further detail in conjunction with FIG. 9 below.

At 810, if the executed check failed. If it is determined that the check did not fail, then, then the method 800 goes at 812, where the result is stored in the check table. However, at 810, if it is determined that the checks failed, then the method 800 goes to 814 then the failed result is also stored in the check table. The results stored here are pre-adjusted by their weightings.

FIG. 9 illustrates a method 900 shows how a single check is performed. At 902, properties to be validated are read. Then, the properties are compared against the defined conditions at 904. The weighting (or rating) of each property is then applied to the result at 906. The result is returned at 908.

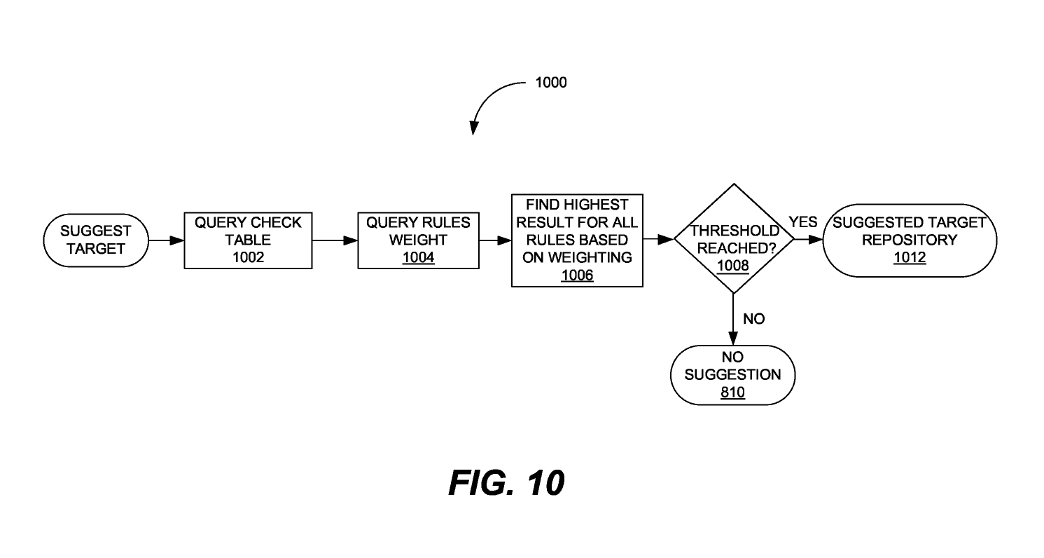

FIG. 10 illustrates a method 1000 of concluding the analyzes and suggest target process. The check table is loaded at 1002. Then, the different checks are weighted (independently from the weighting per property) as defined in the rule at 1004. Then, at 1006, the highest result(s) for all rules bases on weighing is found. At 1008, if it is determined that a threshold has not been reached, then the method 1000 concludes at 1010 with no suggested target repository. However, at 1008, if it is determined that the threshold has been reached, then the method 1000 concludes at 1012 with one or more suggested target repositories. For example, the output of the method 1000 may be a collection of container IDs, item IDs and their top three suggested targets to match all required criteria's as a percentage.

According to some embodiments, a method of advanced data analysis for determining the most suitable target system for data stored on one or more legacy systems is disclosed. The disclosed system may include a) a repository engine (such as the repository engine 306) for the source systems, b) a repository engine (such as the repository engine 308) to determine the features available in the target system, and c) an analysis engine (such as the analysis engine 310), that analyzes the source characteristics and assigns weights to the different data properties taking the available features of the target system into consideration.

The most complete version of the data analysis method may be initiated by an administrator for one or more legacy systems (such as the source system 302) and one or more modern target system (such as the target system 304). The process may be executed by a data migration system which may be a computer having access to the legacy system (such as the source system 302) as well as the modern system (such as the target system 304). Alternatively, an administrator may conduct the analysis through a cloud service. In this case, the described data repository engine may be installed on-premises in the security boundaries of the customer, while the analysis engine resides in the cloud.

During the initialization phase of the analysis engine, the computer that hosts the analysis engine may send a command to the repository engine for the target system with the required information (e.g. Credentials, Connection String) to access the target system. The repository engine then determines which features and desired data formats are available on the target system and transfers them back as a schema (similar to the schema 600) to the analysis engine. In addition, the analysis rules may be defined in the target schema (such as rule 702).

In parallel, a command may be send to the data repository engine for the source system to fetch the characteristics and data properties of the items and records stored on the legacy system. The results are transmitted back as a schema (similar to the schema 600) to the analysis engine which stores them either in memory, on disk or in a database.

As soon the initialization is completed, the analysis engine starts the main analysis process (similar to the method 500 described above) and starts performing the required checks against the transmitted and collected metadata.

For example, in the case of public folder data the predefined—but extendable-checks include:

1) Determine the users that have access to one or more folders so that data that is associated with other data is assessed as a candidate to be moved together to a new target repository, 2) Assessment if the permissions assigned to allow users to access different data so that the movement of data to a new repository does not inadvertently compromise security in any way. 3) Assessment of the different types of data held in repositories against the capabilities of different target repositories to host and utilize the data after it is moved. There is no point in moving data to a repository if the data can no longer be used for its intended purpose. For example, a calendar appointment is unusable if moved to a repository with no knowledge of being able to process calendar items. 4) Assessment of how and when users access the data so that they are able to continue to access the data in a convenient manner after the data is moved to the new repository. For instance, if users are able to access data via a web browser in the old repository, this should also be possible in the new. 5) Assess traffic patterns for data in the old repository so that the selected new repository is capable of handling the moved data in a responsive and secure manner. 6) Assess the absolute age of data and the time when it was last accessed in order to identify data that is possibly obsolete and is therefore a candidate for removal, subject to other considerations such as the need to comply with legal or industry regulations governing data retention.

Based on the weighting a suitable target for a subset of data is suggested ((similar to the method 800 described above). If different target repositories are suitable, for instance in Microsoft Office 365 (shared mailboxes, modern public folders, PST-Files and SharePoint Sites and Office 365 Groups), the analysis engine may suggest to split the legacy data across those different repositories or offer more than one possibility.

### Exemplary Embodiments

According to some embodiments of the present disclosure, a computer implemented method of facilitating data migration is disclosed. The computer implemented method includes receiving, using a processor, at least one data characteristic associated with a source data, wherein the source data is stored in a source repository. The at least one data characteristic may include at least one of a size, an age, a content type and an ownership. The source data may include a public folder. Further, the computer implemented method includes receiving, using the processor, at least one repository characteristic associated with at least one target repository.

Further, the computer implemented method includes analyzing, using the processor, the at least one data characteristic and the at least one repository characteristic. The analyzing may further include comparing the at least one data characteristic with the at least one repository characteristic based on an association between a plurality of data characteristics and a plurality of repository characteristics. Moreover, the analyzing may include executing at least one rule against the at least one data characteristic, wherein determining the at least one target repository is based on a result of executing the at least one rule. The at least one rule may include a plurality of rules, wherein the analyzing further comprises determining a weighted combination of results of executing the plurality of rules, wherein determining the at least one target repository is based on the weighted combination. The computer implemented method may also include assigning, using the processor, at least one weight to the at least one data characteristic, wherein the analyzing is performed based on the at least one weight.

Yet further, the computer implemented method includes determining, using the processor, at least one target repository based on the analyzing. The at least one target repository may be characterized by at least one hardware characteristic and at least one software characteristic. Further, the computer implemented method may include determining at least one confidence value associated with the at least one target repository, wherein a confidence value associated with a target repository is indicative of an extent of suitability of the target repository for storing the source data.

The computer implemented method may include presenting, using a presentation device, indication of the at least one target repository to a user; and receiving, using an input device, a selection of a target repository of the at least one target repository.

The computer implemented method may include determining, using the processor, at least one repository characteristic associated with the at least one target repository, wherein analyzing the at least one data characteristic is based on the at least one repository characteristic. Further, the at least one data characteristic may include at least one of a mode of access, a security level and a throughput, wherein the at least one target repository may be compatible with respectively at least one of the mode of access, the security level and the throughput.

Moreover, the computer implemented method may include migrating, using the processor, the source data to the at least one target repository. The computer implemented method may also include transforming, using the processor, the source data into a target data based on at least one target schema associated with the at least one target repository. Also, the computer implemented method may include splitting, using the processor, the source data into a plurality of source data, wherein the at least one data characteristic comprises a plurality of data characteristics, wherein the at least one target repository comprises a plurality of target repositories associated with the plurality of data characteristics.

The computer implemented method may include analyzing, using the processor, at least one of the source data and a metadata associated with the source data to determine the at least one data characteristic.

According to some embodiments, a system for facilitating data migration is disclosed. The system comprising a processor configured to receive at least one data characteristic associated with a source data, wherein the source data is stored in a source repository. The at least one data characteristic may include at least one of a size, an age, a content type and an ownership. The source data may include a public folder.

The processor is also configured to analyze the at least one data characteristic, determine at least one target repository based on the analyzing and migrate the source data to the at least one target repository. The analysis may include comparison of the at least one data characteristic with the at least one repository characteristic, wherein the system further comprises a storage device configured to store an association between a plurality of data characteristics associated with and a plurality of repository characteristics, wherein the comparison is performed based on the association.

The analysis may include execution of at least one rule against the at least one data characteristic, wherein determination of the at least one target repository is based on a result of the execution of the at least one rule. The at least one rule comprises a plurality of rules, wherein the analysis further comprises determination of a weighted combination of results of execution of the plurality of rules, wherein determination of the at least one target repository is based on the weighted combination.

The processor may be further configured to assign at least one weight to the at least one data characteristic, wherein the analysis is performed based on the at least one weight.

The processor is also configured to determine at least one target repository based on the analyzing. The processor may be further configured to determine at least one confidence value associated with the at least one target repository, wherein a confidence value associated with a target repository is indicative of an extent of suitability of the target repository for storing the source data. The at least one target repository may be characterized by at least one hardware characteristic and at least one software characteristic. The processor may be further configured to determine at least one repository characteristic associated with the at least one target repository, wherein the analysis of the at least one data characteristic is based on the at least one repository characteristic.

Further, the at least one data characteristic may include at least one of a mode of access, a security level and a throughput, wherein the at least one target repository may be compatible with respectively at least one of the mode of access, the security level and the throughput.

Moreover, the processor may be further configured to present, using a presentation device, indication of the at least one target repository to a user; and receive, using an input device, a selection of a target repository of the at least one target repository.

The processor is also configured to migrate the source data to the at least one target repository. The processor may be further configured to transform the source data into a target data based on at least one target schema associated with the at least one target repository.

The processor is also configured split the source data into a plurality of source data, wherein the at least one data characteristic comprises a plurality of data characteristics, wherein the at least one target repository comprises a plurality of target repositories associated with the plurality of data characteristics.

The processor is further configured to analyze at least one of the source data and a metadata associated with the source data to determine the at least one data characteristic.

Although the invention has been explained in relation to its preferred embodiment, it is understood that many other possible modifications and variations can be made without departing from the spirit and scope of the invention as herein described.

I claim:

1. A computer implemented method of facilitating data migration, the computer implemented method comprising:
receiving, using a processor, at least one data characteristic associated with a source data, wherein the source data is stored in a source repository;
receiving, using the processor, at least one repository characteristic associated with at least one target repository;
analyzing, using the processor, the at least one data characteristic and the at least one repository characteristic;
determining, using the processor, at least one target repository based on the analyzing; and
migrating, using the processor, the source data to the at least one target repository.

2. The computer implemented method of claim 1 further comprising transforming, using the processor, the source data into a target data based on at least one target schema associated with the at least one target repository.

3. The computer implemented method of claim 1 further comprising:
presenting, using a presentation device, indication of the at least one target repository to a user; and
receiving, using an input device, a selection of a target repository of the at least one target repository.

4. The computer implemented method of claim 1, wherein the analyzing comprises comparing the at least one data characteristic with the at least one repository characteristic based on an association between a plurality of data characteristics and a plurality of repository characteristics.

5. The computer implemented method of claim 1 further comprising splitting, using the processor, the source data into a plurality of source data, wherein the at least one data characteristic comprises a plurality of data characteristics, wherein the at least one target repository comprises a plurality of target repositories associated with the plurality of data characteristics.

6. The computer implemented method of claim 1, wherein the analyzing comprises executing at least one rule against the at least one data characteristic, wherein determining the at least one target repository is based on a result of executing the at least one rule.

7. The computer implemented method of claim 6, wherein the at least one rule comprises a plurality of rules, wherein the analyzing further comprises determining a weighted combination of results of executing the plurality of rules, wherein determining the at least one target repository is based on the weighted combination.

8. The computer implemented method of claim 1 further comprising determining, using the processor, at least one confidence value associated with the at least one target repository, wherein a confidence value associated with a target repository is indicative of an extent of suitability of the target repository for storing the source data.

9. The computer implemented method of claim 1 further comprising assigning, using the processor, at least one weight to the at least one data characteristic, wherein the analyzing is performed based on the at least one weight.

10. The computer implemented method of claim 1 further comprising analyzing, using the processor, at least one of the source data and a metadata associated with the source data to determine the at least one data characteristic.

11. A system for facilitating data migration, the system comprising a processor configured to:
receive at least one data characteristic associated with a source data, wherein the source data is stored in a source repository;
receive at least one repository characteristic associated with at least one target repository;
analyze the at least one data characteristic and the at least one repository characteristic;
determine at least one target repository based on the analyzing; and
migrate the source data to the at least one target repository.

12. The system of claim 11, wherein the processor is further configured to transform the source data into a target data based on at least one target schema associated with the at least one target repository.

13. The system of claim 11, wherein the processor is further configured to:
present, using a presentation device, indication of the at least one target repository to a user; and
receive, using an input device, a selection of a target repository of the at least one target repository.

14. The system of claim 11, wherein the analysis comprises comparison of the at least one data characteristic with the at least one repository characteristic, wherein the system further comprises a storage device configured to store an association between a plurality of data characteristics and a plurality of repository characteristics, wherein the comparison is performed based on the association.

15. The system of claim 11, wherein the processor is further configured to split the source data into a plurality of source data, wherein the at least one data characteristic comprises a plurality of data characteristics, wherein the at least one target repository comprises a plurality of target repositories associated with the plurality of data characteristics.

16. The system of claim 11, wherein the analysis comprises execution of at least one rule against the at least one data characteristic, wherein determination of the at least one target repository is based on a result of the execution of the at least one rule.

17. The system of claim 16, wherein the at least one rule comprises a plurality of rules, wherein the analysis further comprises determination of a weighted combination of results of execution of the plurality of rules, wherein determination of the at least one target repository is based on the weighted combination.

18. The system of claim 11, wherein the processor is further configured to determine at least one confidence value associated with the at least one target repository, wherein a confidence value associated with a target repository is indicative of an extent of suitability of the target repository for storing the source data.

19. The system of claim 11, wherein the processor is further configured to assign at least one weight to the at least one data characteristic, wherein the analysis is performed based on the at least one weight.

20. The system of claim 11, wherein the processor is further configured to analyze at least one of the source data and a metadata associated with the source data to determine the at least one data characteristic.
